(19) United States
(12) Patent Application Publication
(10) Pub. No.: US 2016/0012519 A1
(43) Pub. Date: Jan. 14, 2016

(54) DROPSALE

(71) Applicant: eBay Inc., San Jose, CA (US)

(72) Inventor: Scott Leach, Pleasanton, CA (US)

(21) Appl. No.: 14/793,352

(22) Filed: Jul. 7, 2015

Related U.S. Application Data
(60) Provisional application No. 62/022,564, filed on Jul. 9, 2014.

(51) Int. Cl. G06Q 30/06; G06Q 50/00

(52) U.S. Cl. CPC G06Q 30/0641; G06Q 50/01

(57) ABSTRACT

A server includes a digital goods application that generates a graphical user interface having a first plurality of entries to receive information of a digital good item, a second plurality of entries to receive a web link to a hosting server configured store a sample of the digital good item, and a third plurality of entries to receive web links to social network services of a content creator of the digital good item. The hosting server corresponds to a format of the digital good item. The digital goods application causes a display of a product link for a sale of the digital good item, a plurality of tabs, and a checkbox in each tab. Each tab corresponds to a social network service. A selection of social network services is identified with a corresponding checked checkbox. The product link is communicated to the selected social network services using the web links in the third plurality of entries.

### RELATED APPLICATION

This application claims priority from U.S. Provisional Patent Application Ser. No. 62/022,564 filed Jul. 9, 2014, entitled “Dropsale,” which is incorporated herein by reference in its entirety.

### TECHNICAL FIELD

This application relates generally to the field of computer technology and, in a specific example embodiment, to a system and method for listing digital goods for sale in an online marketplace.

### BACKGROUND

Websites provide a number of publishing, listing, and price-setting mechanisms whereby a publisher (e.g., a seller) may list or publish information concerning items for sale. Once a buyer places an order for an item, the seller fulfills the order by providing the item to the buyer.

Items listed for sale typically include physical goods that can be shipped. On the other hand, digital goods are stored in a remote server and require a different computing infrastructure to enable the listing and selling of digital goods.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram depicting various components of a network-based publication system, in accordance with some embodiments;

FIG. 3 is a block diagram depicting various components of a digital goods application, in accordance with some embodiments;

FIG. 4A is a flow diagram illustrating an example embodiment of a process for operating the digital goods application;

FIG. 4B is a flow diagram illustrating an example embodiment of a process for presenting analytics data related digital goods listed in a marketplace application;

FIG. 4C is a flow diagram illustrating an example embodiment of a process for providing publication settings of digital goods with the digital goods application;

FIG. 4D is a flow diagram illustrating an example embodiment of a process for promoting digital goods to targeted users of the marketplace application;

FIG. 5 shows a diagrammatic representation of a machine in the example form of a computer system within which a set of instructions may be executed to cause the machine to perform any one or more of the methodologies discussed herein;

FIG. 6 is a block diagram illustrating a mobile device, according to an example embodiment.

FIG. 7 is a diagram illustrating an example of a graphical user interface for selling digital goods.

FIG. 8 is a diagram illustrating an example of a graphical user interface for downloading digital goods.

FIG. 9 is a diagram illustrating an example of a graphical user interface for viewing purchased digital goods.

FIG. 10 is a diagram illustrating an example of a graphical user interface for viewing uploaded digital goods.

FIG. 11 is a diagram illustrating an example of a graphical user interface for uploading digital goods.

FIG. 12 is a diagram illustrating an example of a graphical user interface for generating a preview and promoting digital goods on social networks.

FIG. 13 is a diagram illustrating an example of a graphical user interface for viewing sales information of digital goods.

FIG. 14 is a diagram illustrating another example of a graphical user interface for viewing sales information of digital goods.

FIG. 15 is a diagram illustrating an example of a graphical user interface for viewing analytics information of digital goods.

FIG. 16 is a diagram illustrating another example of a graphical user interface for viewing analytics information of digital goods.

FIG. 17 is a diagram illustrating an example of a graphical user interface for promoting digital goods on social networks.

FIG. 18 is a diagram illustrating an example of a graphical user interface for managing a status of digital goods.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

The present application describes a system (also referred to as digital goods application or DropSale) for listing, selling, and buying digital goods using an online marketplace application. Digital goods include, for example, a music file, a picture file, a video, a text file (e.g., a novel). A content creator (e.g., a music band) can upload a digital file to a website of the online marketplace application by dragging a file containing the music from their computer to their web browser. The content creator can then set a price for the file, and receive a short URL that links to a product page on the website of the online marketplace for the file. Communication tools and targeted communication enable the content creator to promote and increase engagement with an audience. In comparison to existing offerings (e.g., Amazon), this process gives the seller more of a presence and more of a direct relationship to their fans, at a far better rate.

In one example embodiment, a server comprises a hardware processor comprising a digital goods application and a marketplace application. The digital goods application generates a graphical user interface having a first plurality of entries to receive information of a digital goods item, a second plurality of entries to receive a web link to a hosting server configured store a sample of the digital good item, the hosting server corresponding a format of the digital goods item, and a third plurality of entries to receive web links to social network services of a content creator of the digital goods item. The digital goods application generates a product link for a sale of the digital goods item in response to receiving data in the first, second, and third plurality of entries. The digital goods application displays a product link, a plurality of tabs, and a checkbox in each tab, each tab corresponding to a social network service, receives a selection of social network services identified with a corresponding checked checkbox, and communicates the product link to the selected social network services using the web links in the third plurality of entries. The marketplace application published a sale listing of the digital good item, a web page of the sale listing corresponding to the product link. A storage device configured to store the digital good item and a corresponding publication setting.

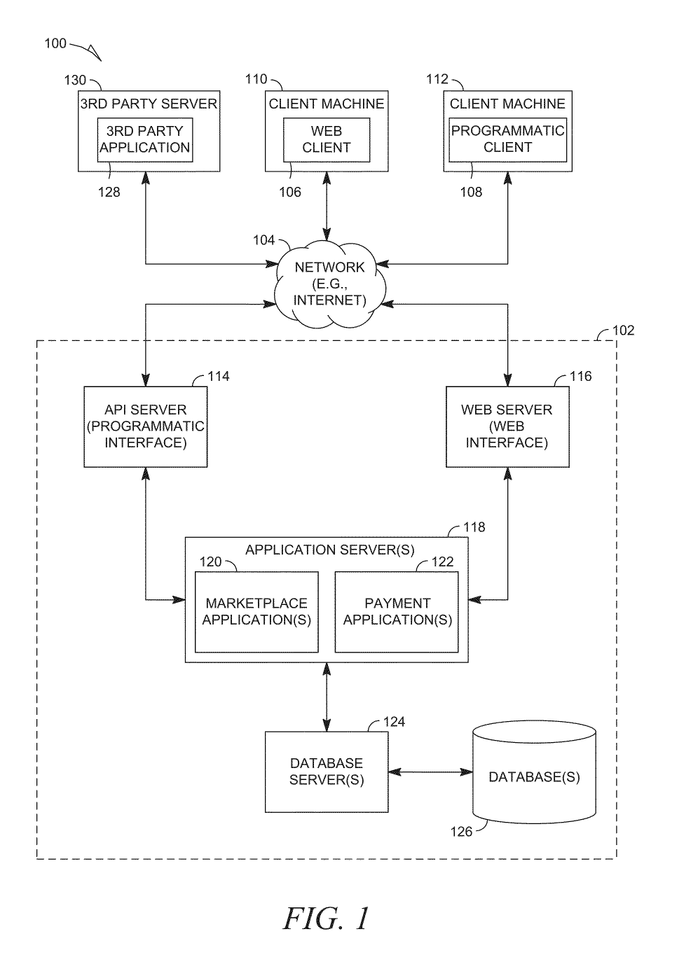

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Washington State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

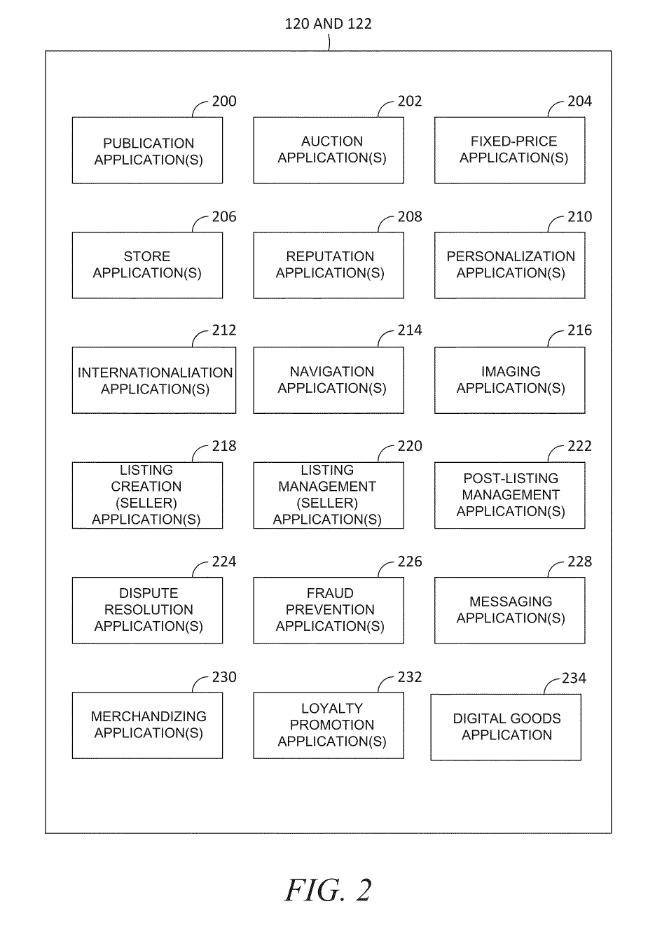

FIG. 2 is a block diagram illustrating the marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

The applications 120 and 122 also include a digital goods application 234 to provide a graphical user interface to receive digital goods from content creators, list the digital goods for sale in the online marketplace, enable the content creators to manage the sale of their digital goods, and to provide tools to promote buyer/user engagement with the content creator of the digital goods on the online marketplace.

The following table illustrates example features of the digital goods application 234:

| | |
|---|---|
| Email Lists | Allows sellers to access emails from |
| | anyone who has purchased from |
| | them. Provides a mechanism for |
| | sellers to email users with new offers. |
| Seller Analytics | Allows sellers to view analytics on |
| | their items: page views, downloads, |
| | etc. |
| C2C | Allow anyone to sign up for the |
| | service |
| Profile Page | Seller Profile page that includes all the |
| | items they have for sale as well as |
| | seller bio |
| Free Download Day | One day a week (or some other |
| | interval), offer a free digital download. |
| Bundles | Allow the seller to create bundles of |
| | content |
| Pre-Order | Allow buyers to pre-order content |
| Affiliate Program | Buyers can get a custom URL to |
| | share a specific item. If the item is |
| | transacted on, the buyer who shared |
| | the link gets a percentage of the sale. |
| Sample Content | Enable sellers to offer a free portion of |
| | their content: first chapter is free, first |
| | 15 minutes of movie, etc. |
| Earn Free Content | Similar to the affiliate program. Users |
| | who share content a specific number |
| | of times get a free download. |
| Group Buying | Digital content is set at a specific |
| | price. Buyers cannot download the |
| | content until a pre-specified number of |
| | users commit to buying. |
| Trending Items | A URL that provides an active listing |
| | of trending/popular items currently for |
| | sale. |
| Buyer Pages | Buyers get a unique, URL that shows |
| | a list of what they've downloaded via |
| | DropSale. Additionally, buyers can |
| | promote content they like most by |
| | bumping it to the top of their page. |
| Activity Feed | This is a URL that displays what items |
| | are being downloaded right now |
| | across the service. |
| DRM | An optional DRM solution to protect |
| | content. |
| Crowd Funding | Allow sellers to raise crowd funding to |
| | create their content |
| Digital Store | Digital goods items |

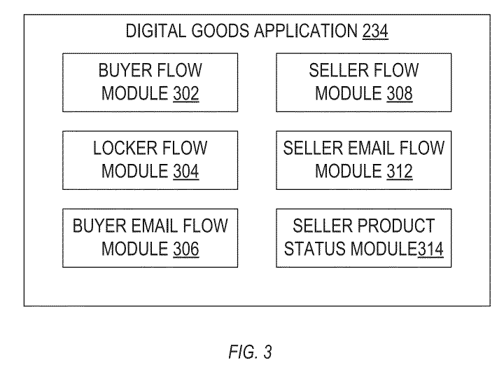

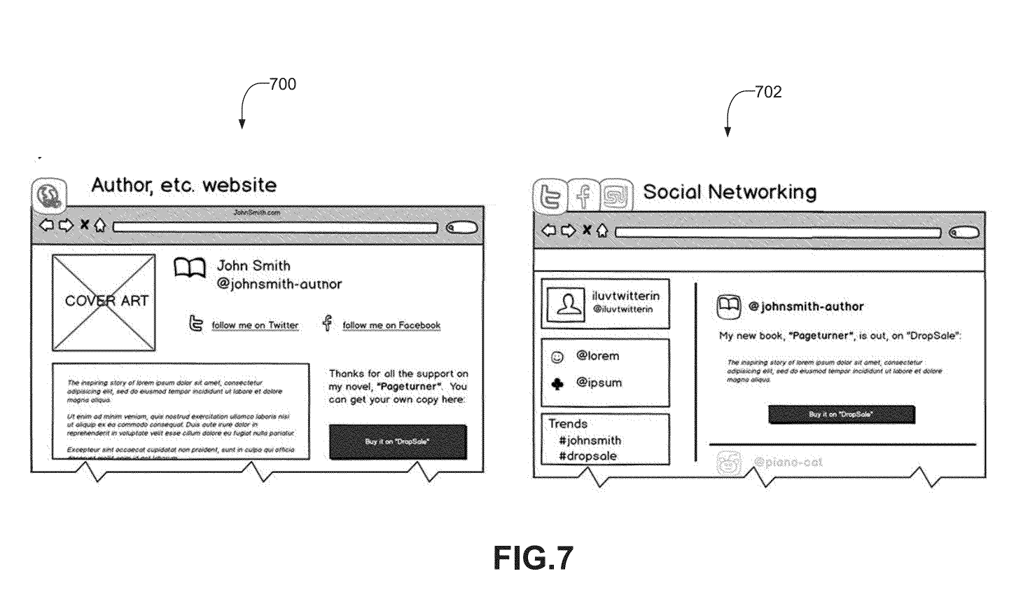

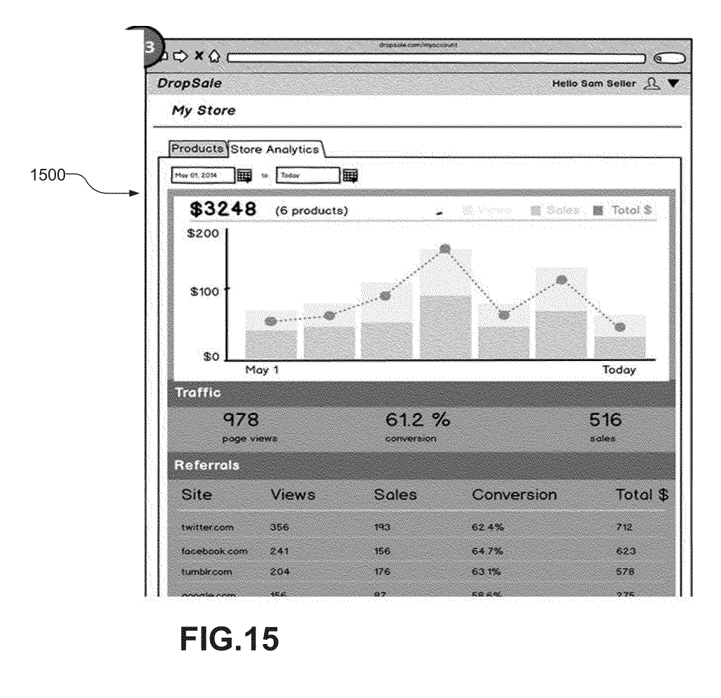

FIG. 3 is a block diagram illustrating an example embodiment of the digital goods application 234. In one embodiment, the digital goods application 234 includes a buyer flow module 302, a locker flow module 304, a buyer email flow module 306, a seller flow module 308, a seller email module 312, and a seller product status module 314. The buyer flow module 302 enables a user to view digital goods in the marketplace application 120 and purchase the goods by downloading them. FIGS. 7-14 illustrate examples of graphical user interfaces for the buyer flow module 302. The locker flow module 304 enables the digital good to be securely stored in the marketplace application 120. FIGS. 15-21 illustrate examples of graphical user interfaces for the locker flow module 304. The email flow module 306 enables a user to access the digital goods via email. FIGS. 22-26 illustrate examples of graphical user interfaces for the buyer email flow module 306. The seller flow module 308 enables a user to upload the digital good via a graphical user interface of the digital goods application 234. FIGS. 27-44 illustrate examples of graphical user interfaces for the seller flow module 308. A seller email flow module 312 enables a user to upload and promote his digital goods via email. FIGS. 45-48 illustrate an example graphical user interface for the seller email flow module 312. A seller product status module 314 enables a user to specify the availability of the digital goods in the marketplace application 120.

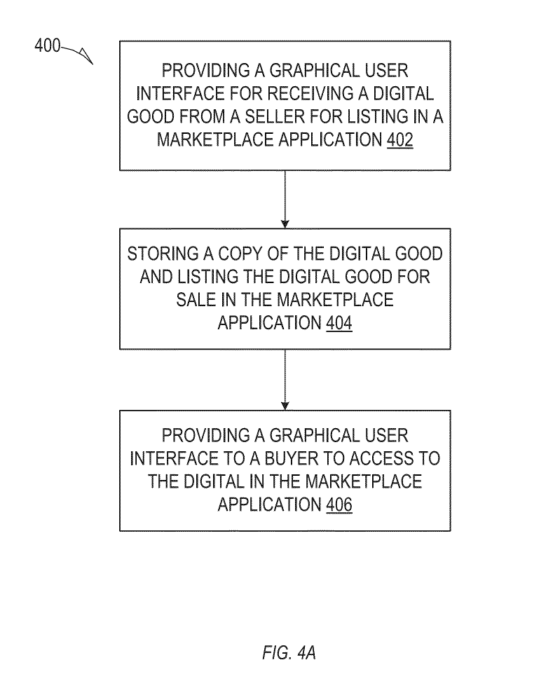

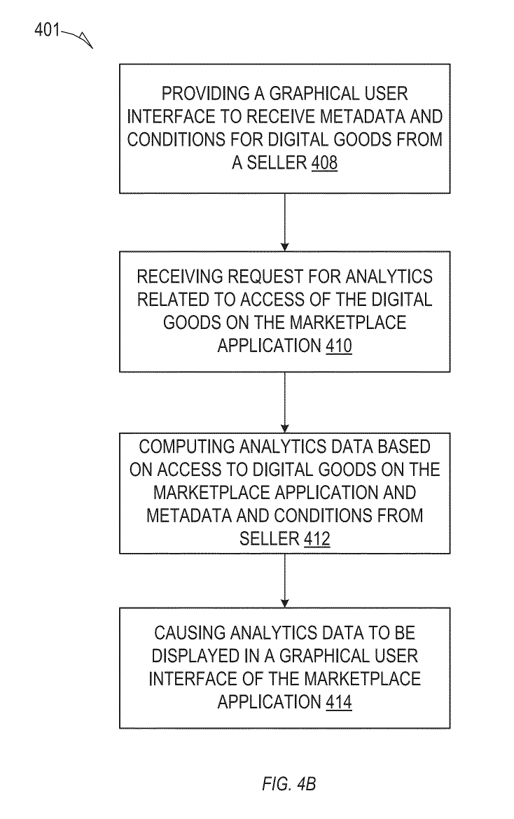

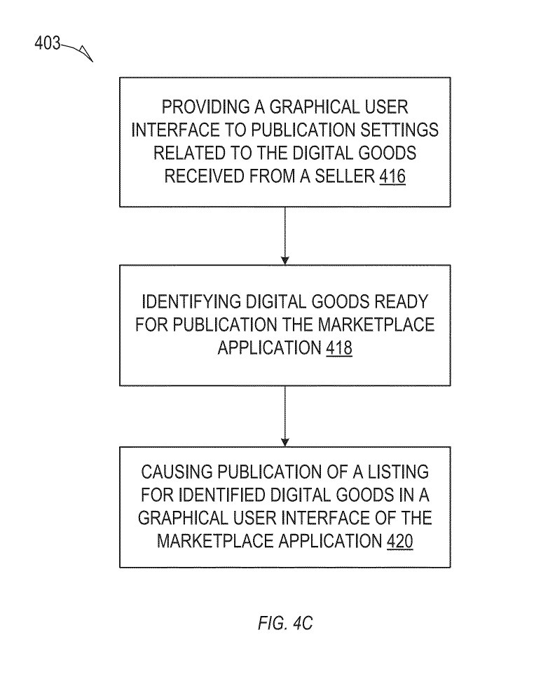

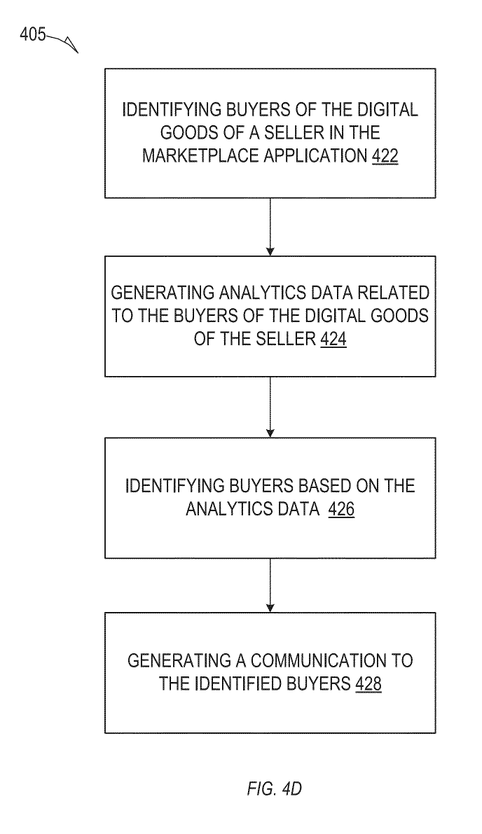

FIG. 4A is a flow diagram illustrating an example embodiment of a process 400 for operating the digital goods application. At operation 402, the digital goods application 234 provides a graphical user interface for receiving a digital good from a seller or author of the digital good for listing in the marketplace application 120. For example, from a client device, the user drags and drops a music file icon into a web browser in communication with the marketplace application 120 to upload the music file.

At operation 404, the digital goods application 234 receives a copy of the digital good (e.g., music file) and stores it in the system 102 for listing in the marketplace application 120. The content creator can set the listing publication to indicate whether to publish or hold off on the listing of the digital good. At operation 406, the digital goods application 234 generates a graphical user interface for a user (e.g., a buyer) to view a listing of the digital good, preview the digital good, and enable the buyer to download the digital good after performing a purchase transaction in the marketplace application 120.

FIG. 4B is a flow diagram illustrating an example embodiment of a process 401 for presenting analytics data related digital goods listed in a marketplace application. At operation 408, the digital goods application 234 provides a graphical user interface to receive metadata related to the digital good (e.g., author, keywords, music genre, reading genre, image quality) and conditions (e.g., minimum bid price, maximum number of limited copies, digital rights management) from the seller. At operation 410, the digital goods application 234 receives a request to perform an analytics operation related to access (e.g., number of downloads) to the digital goods or access to the listing of the digital goods in the marketplace application 120. The analytics operation may include, for example, identifying which referring website (e.g., linked website) provided access to the listing, the number of views for each corresponding website, the number of sales, a sale conversion rate, a social presence indicator, and a historical sales chart. For example, the request may include computing historical sales chart based on the different referring websites. At operation 412, the digital goods application 234 computes and operates on the analytics data to generate, for example, the historical sales chart based on the different referring websites. Other examples of analytics operation include computing statistical operations on the sales or view data. In another example embodiment, the digital goods application 234 computes analytics data based on access to the digital goods, metadata, and conditions received at operation 408. For example, the digital goods application 234 computes a bidding history based on limited available copies of a digital good, or an average or median sales price. At operation 414, the digital goods application 234 causes a display of the analytics data in a graphical user interface of the marketplace application 120.

FIG. 4C is a flow diagram illustrating an example embodiment of a process 403 for providing publication settings of digital goods with the digital goods application. At operation 416, the digital goods application 234 provides a graphical user interface to manage publication settings related to the digital goods received from a content provider (e.g., a seller). The publication settings enable the seller to identify which digital goods are ready for listing or publication. At operation 418, the digital goods application 234 identifies which digital goods are ready for publication. At operation 420, the digital goods application 234 causes the publication of a listing for the identified digital goods in the graphical user interface.

FIG. 4D is a flow diagram illustrating an example embodiment of a process 405 for promoting digital goods to targeted users of the marketplace application. At operation 422, buyers of digital goods from a seller are identified. At operation 424, the digital goods application 234 generates analytics data related to the buyers of the digital goods of the seller. At operation 426, the digital goods application 234 identifies buyers based on the analytics data (e.g., buyers that bought the most or the least number of digital goods from the seller). At operation 428, the digital goods application 234 generates a graphical user interface for the seller to target and communicate with the identified buyers via email or social media.

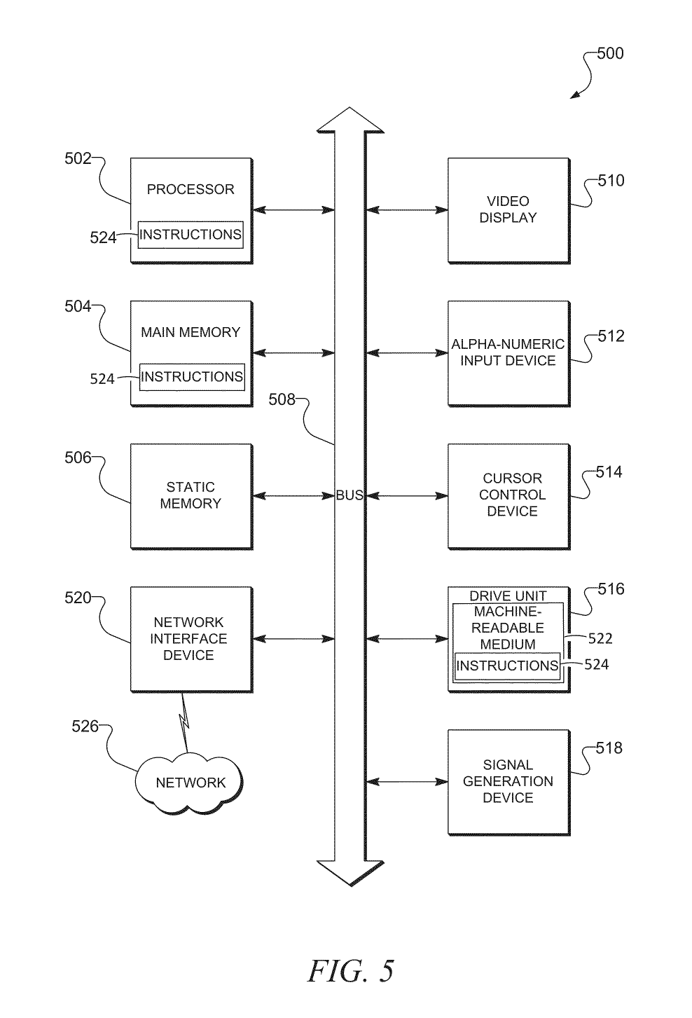

FIG. 5 shows a diagrammatic representation of a machine in the example form of a computer system 500 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a UI navigation device 514 (e.g., a mouse), a drive unit 516, a signal generation device 518 (e.g., a speaker) and a network interface device 520.

The drive unit 516 includes a machine-readable medium 522 on which is stored one or more sets of instructions and data structures (e.g., instructions 524) embodying or utilized by any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media.

The instructions 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

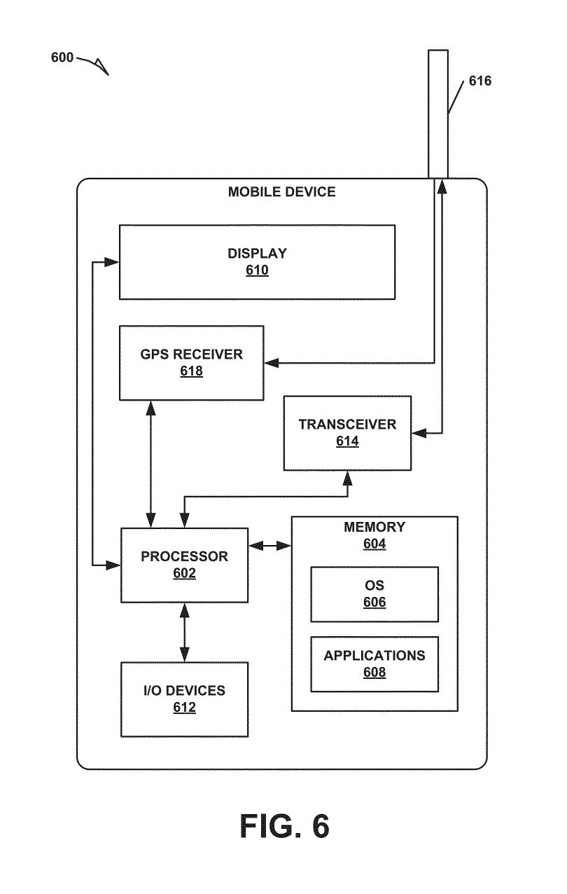

FIG. 6 is a block diagram illustrating a mobile device 600, according to an example embodiment. The mobile device 600 may include a processor 602. The processor 602 may be any of a variety of different types of commercially available processors 602 suitable for mobile devices 600 (for example, an XScale architecture microprocessor, a microprocessor without interlocked pipeline stages (MIPS) architecture processor, or another type of processor 602). A memory 604, such as a random access memory (RAM), a flash memory, or other type of memory, is typically accessible to the processor 602. The memory 604 may be adapted to store an operating system (OS) 606, as well as application programs 608, such as a mobile location enabled application that may provide location-based services (LBSs) to a user. The processor 602 may be coupled, either directly or via appropriate intermediary hardware, to a display 610 and to one or more input/output (I/O) devices 612, such as a keypad, a touch panel sensor, a microphone, and the like. Similarly, in some embodiments, the processor 602 may be coupled to a transceiver 614 that interfaces with an antenna 616. The transceiver 614 may be configured to both transmit and receive cellular network signals, wireless data signals, or other types of signals via the antenna 616, depending on the nature of the mobile device 600. Further, in some configurations, a GPS receiver 618 may also make use of the antenna 616 to receive GPS signals.

FIG. 7 is a diagram illustrating an example of a graphical user interface for selling digital goods. Graphical user interface (GUI) 700 illustrates an example of a seller's website promoting a digital good (e.g., a book). Graphical user interface 702 illustrates an example of a seller's social network page. Both GUI feature a link or a button to buy the digital good.

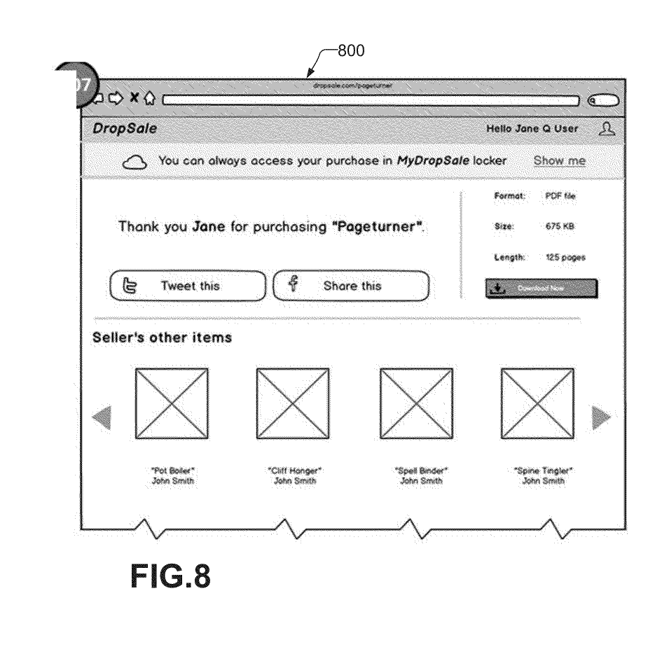

FIG. 8 is a diagram illustrating an example of a graphical user interface 800 for downloading digital goods. After the user clicked on “buy on DropSale” button, the user is redirected to the digital item's product page showing the item's metadata (e.g., author, title, price, and format details) and a description of the digital item. The user can click on “read an excerpt” to open a popup window that allow for the media-specific preview. For books, sample pages may be provided. For video, a video clip or sample may be provided.

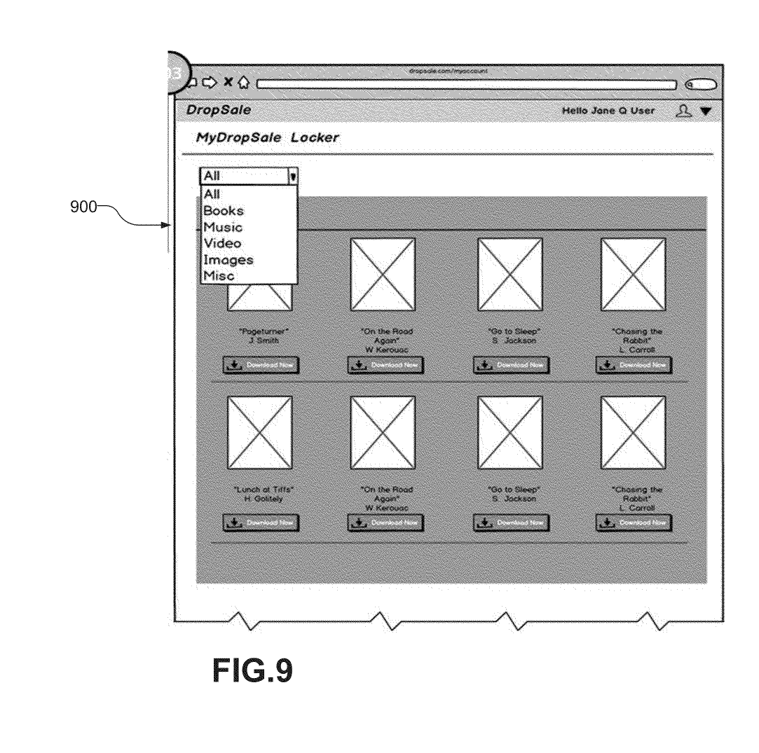

FIG. 9 is a diagram illustrating an example of a graphical user interface 900 for viewing purchased digital goods. For example, a list of previously purchased digital goods is displayed along with an option to re-download the digital good. A filter may be applied to filter the display by type of digital goods (e.g., books, music, video, images, etc).

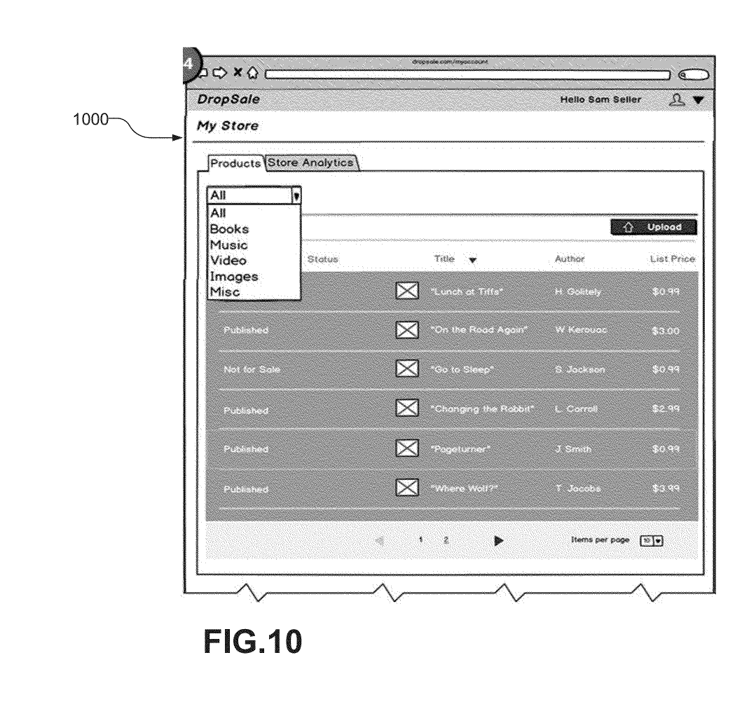

FIG. 10 is a diagram illustrating an example of a graphical user interface 1000 for viewing uploaded digital goods from a content creator point of view. For example, a list of previously uploaded digital goods is displayed along a publication status, a title, an author, and a list price. A filter may be applied to filter the display by type of digital goods (e.g., books, music, video, images, etc).

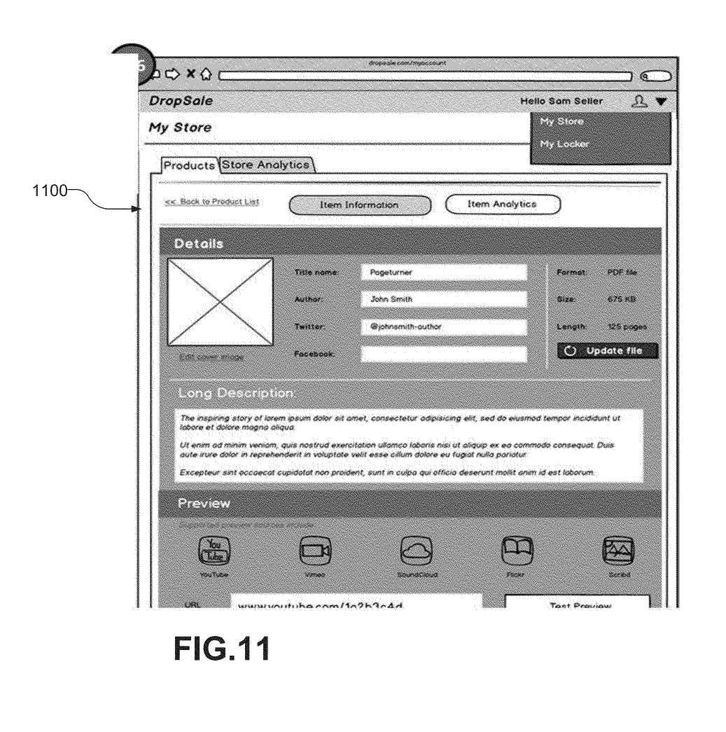

FIG. 11 is a diagram illustrating an example of a graphical user interface 1100 for uploading digital goods. The GUI 1100 includes entry fields for information related to the digital good (e.g., title, author, social network affiliation, description). The GUI 1100 enables the content creator to provide information of the digital good and enables preview of the digital good.

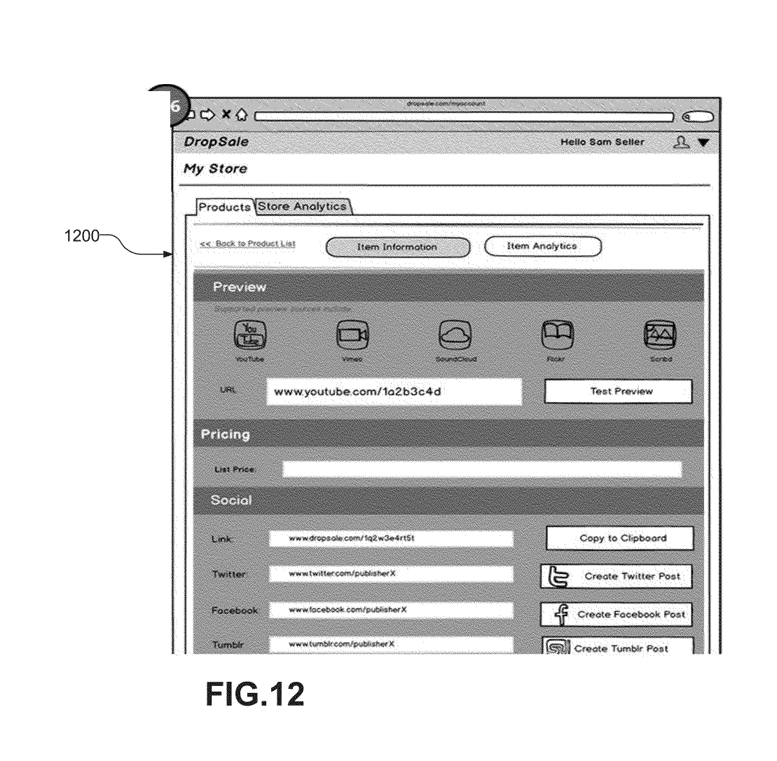

FIG. 12 is a diagram illustrating an example of a graphical user interface 1200 for generating a preview and promoting digital goods on social networks. The GUI 1100 enables the content creator to enable preview of the digital good via a corresponding relevant channel (e.g., YouTube, Vimeo, SoundCloud) based on the format and type of the digital good. The GUI 1100 also includes social network links to promote the digital good. From a single or common GUI 1100, the content creator can promote the digital good by posting an announcement on social networks.

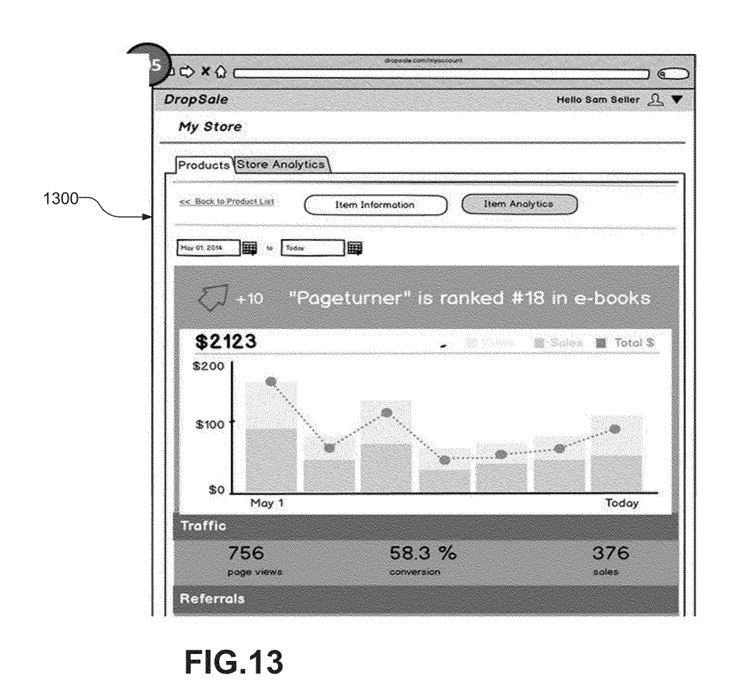

FIG. 13 is a diagram illustrating an example of a graphical user interface 1300 for viewing sales information of digital goods. The GUI 1300 includes a chart of sales history along with traffic information include page views, conversion rates, and sales figures).

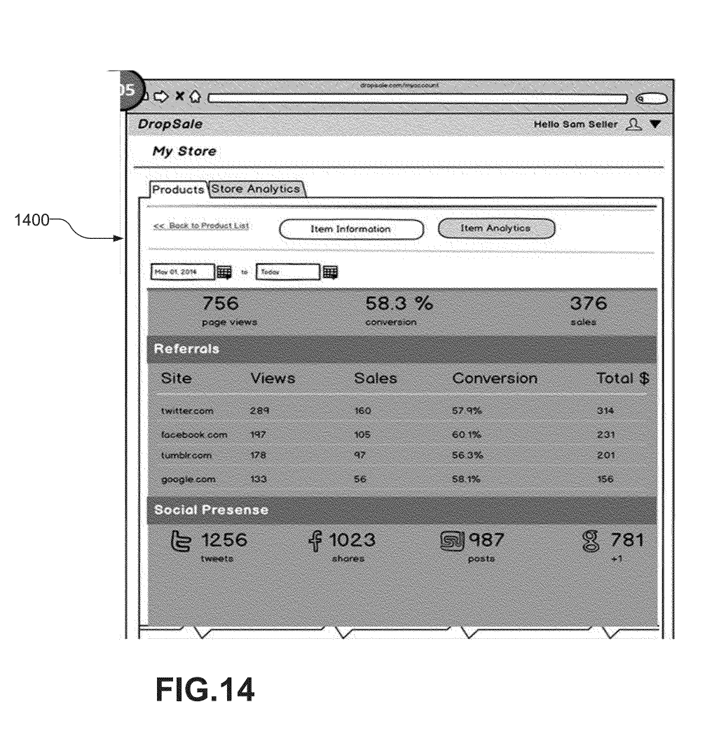

FIG. 14 is a diagram illustrating another example of a graphical user interface 1400 for viewing sales information of digital goods. The GUI 1400 also displays referrals information (which site provided the incoming link) and social presence data (e.g., number of tweets, sharing, posts on corresponding social networks).

FIG. 15 is a diagram illustrating an example of a graphical user interface 1500 for viewing analytics information of digital goods. The analytics information includes a chart of sales history, web traffic information, sites, corresponding views, corresponding sales, corresponding conversion, and corresponding total amount.

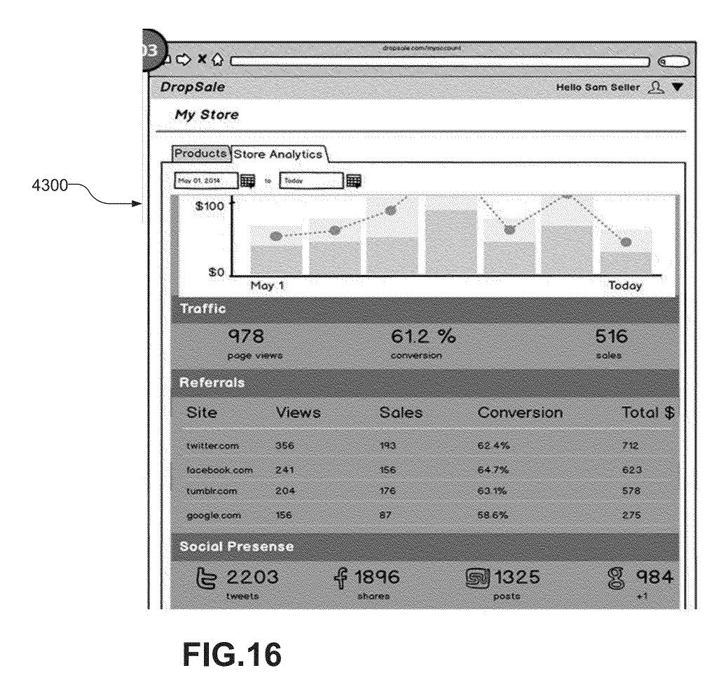

FIG. 16 is a diagram illustrating another example of a graphical user interface 1600 for viewing analytics information of digital goods. The analytics information also includes social presence data (e.g., number of tweets, sharing, posts on corresponding social networks).

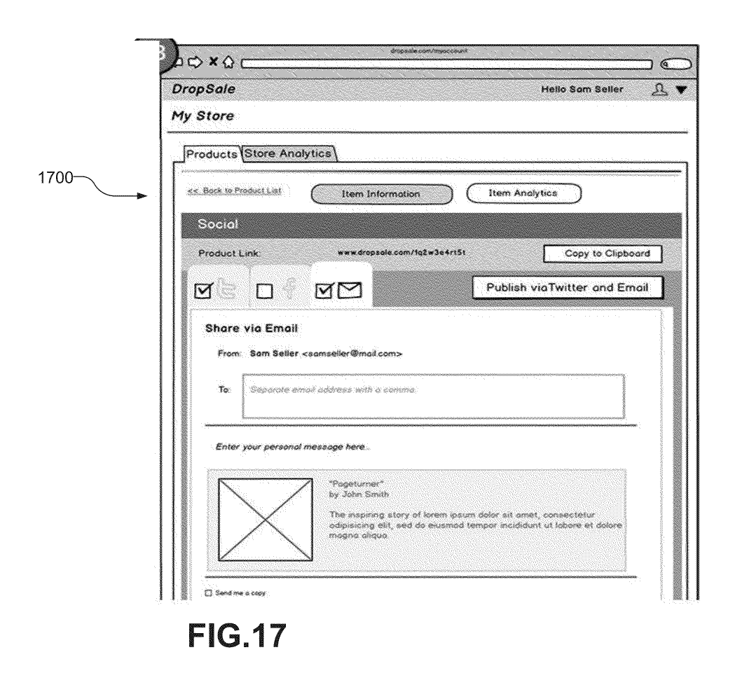

FIG. 17 is a diagram illustrating an example of a graphical user interface 1700 for promoting digital goods on social networks. A product link is generated and provided. The product link can be posted on several social networks from the GUI 1700.

FIG. 18 is a diagram illustrating an example of a graphical user interface 1800 for managing a status of digital goods. For example, the content creator can upload a digital file and specify whether to publish and list the digital file, or prevent it from publication.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A server comprising:
a hardware processor comprising a digital goods application and a marketplace application,
the digital goods application configured to generate a graphical user interface having a first plurality of entries to receive information of a digital good item, a second plurality of entries to receive a web link to a hosting server configured store a sample of the digital good item, the hosting server corresponding a format of the digital good item, and a third plurality of entries to receive web links to social network services of a content creator of the digital good item, to generate a product link for a sale of the digital good item in response to receiving data in the first, second, and third plurality of entries, to cause a display of the product link, a plurality of tabs, and a checkbox in each tab, each tab corresponding to a social network service, to receive a selection of social network services identified with a corresponding checked checkbox, to communicate the product link to the selected social network services using the web links in the third plurality of entries, and
the marketplace application configured to publish a sale listing of the digital good item, a web page of the sale listing corresponding to the product link; and
a storage device configured to store the digital good item and a corresponding publication setting.

2. The server of claim 1, wherein the digital goods application configured to receive a digital good item from a seller of the marketplace application, to receive metadata and selling conditions of the digital good item, and to provide access to the digital good item based on the metadata and selling conditions in the marketplace application.

3. The server of claim 1, wherein the product link includes a webpage of the seller.

4. The server of claim 1, wherein the digital goods application is configured to generate a posting to a social network account of a buyer of the digital good item in response to a sale of the digital good item in the marketplace application.

5. The server of claim 1, wherein the digital goods application is configured to generate a preview of the digital good item based on a format of the digital good item.

6. The server of claim 1, wherein the digital goods application is configured to generate analytics data based on transactions related to a number of views of the listing of the digital good item, a number of accesses to preview the digital good item, and a number of sales of the digital good item in the marketplace application.

7. The server of claim 6, wherein the digital goods application is configured to compute a conversion rate of the digital good item based on the number of views of the listing of the digital good item, the number of accesses to preview the digital good item, and the number of sales of the digital good in the marketplace application

8. The server of claim 1, wherein the digital goods application is configured to identify previous buyers of the digital good item, and generate a communication to the previous buyers, the communication including a link to the listing of the digital good item on the marketplace application.

9. The server of claim 1, wherein the digital goods application is configured to receive a publication setting related to the digital good item, the publication setting identifying whether the received digital good item is to be listed and published on the marketplace application.

10. The server of claim 1, wherein the metadata include an author, a keyword, a music genre, a reading genre, or an image quality, and the selling conditions include a minimum bid price or a maximum number of limited copies.

11. A computer-implemented method comprising:
generating, using a hardware processor of a server, a graphical user interface having a first, second, and third plurality of entries;
receiving information of a digital good item in the first plurality of entries;
receiving a web link to a hosting server in the second plurality of entries, the hosting server corresponding a format of the digital good item and configured to store a sample of the digital good item;
receiving web links to social network services of a content creator of the digital good item in the third plurality of entries;
generating a product link for a sale of the digital good item in response to receiving data in the first, second, and third plurality of entries;
causing a display of the product link, a plurality of tabs, and a checkbox in each tab, each tab corresponding to a social network service;
receiving a selection of social network services identified with a corresponding checked checkbox;
communicating the product link to the selected social network services using the web links in the third plurality of entries; and
publishing a sale listing of the digital good item in a marketplace application, a web page of the sale listing corresponding to the product link.

12. The computer-implemented method of claim 11, further comprising:
receiving a digital good item from a seller of the marketplace application;
receiving metadata and selling conditions of the digital good item; and
providing access to the digital good item based on the metadata and selling conditions in the marketplace application.

13. The computer-implemented method of claim 11, wherein the product link includes a webpage of the seller.

14. The computer-implemented method of claim 11, further comprising:
generating a posting to a social network account of a buyer of the digital good item in response to a sale of the digital good item in the marketplace application.

15. The computer-implemented method of claim 11, further comprising:
generating a preview of the digital good item based on a format of the digital good item.

16. The computer-implemented method of claim 11, further comprising:
generating analytics data based on transactions related to a number of views of the listing of the digital good item, a number of accesses to preview the digital good item, and a number of sales of the digital good item in the marketplace application.

17. The computer-implemented method of claim 16, further comprising:
computing a conversion rate of the digital good item based on the number of views of the listing of the digital good item, the number of accesses to preview the digital good item, and the number of sales of the digital good item in the marketplace application

18. The computer-implemented method of claim 11, further comprising:
identifying previous buyers of the digital good item; and
generating a communication to the previous buyers, the communication including a link to the listing of the digital good item on the marketplace application.

19. The computer-implemented method of claim 11, further comprising:
receiving a publication setting related to the digital good item, the publication setting identifying whether the received digital good is to be listed and published on the marketplace application.

20. A non-transitory computer-readable storage medium storing a set of instructions that, when executed by a processor of a machine, cause the machine to perform operations, comprising:
generating, using a hardware processor of a server, a graphical user interface having a first, second, and third plurality of entries;
receiving information of a digital good item in the first plurality of entries;
receiving a web link to a hosting server in the second plurality of entries, the hosting server corresponding a format of the digital good item and configured to store a sample of the digital good item;
receiving web links to social network services of a content creator of the digital good item in the third plurality of entries;
generating a product link for a sale of the digital good item in response to receiving data in the first, second, and third plurality of entries;
causing a display of the product link, a plurality of tabs, and a checkbox in each tab, each tab corresponding to a social network service;
receiving a selection of social network services identified with a corresponding checked checkbox;
communicating the product link to the selected social network services using the web links in the third plurality of entries; and
publishing a sale listing of the digital good item in a marketplace application, a web page of the sale listing corresponding to the product link.
